(19) United States
(12) Patent Application Publication
(10) Pub. No.: US 2005/0138277 A1
(43) Pub. Date: Jun. 23, 2005

(54) Data control circuit for DDR SDRAM controller

(75) Inventor: Tae-woon Koo, Suwon-Si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/914,262

(22) Filed: Aug. 10, 2004

(30) Foreign Application Priority Data
Dec. 18, 2003 (KR) 2003-93226

(51) Int. Cl. G06F 13/00

(52) U.S. Cl. 711/105

(57) ABSTRACT

A data control circuit for a double data rate (DDR) synchronous dynamic random-access memory (SDRAM) that secures a stable reading/writing operation of DDR SDRAM data by generating an actively controllable internal data strobe signal. The data control circuit includes an internal data strobe signal generating circuit generating and outputting an internal data strobe signal a rising edge of which is located in a center part of valid DDR SDRAM data; a read data control circuit for receiving the internal data strobe signal, generated from the internal data strobe signal generating circuit as a clock input, dividing captured data into even data and odd data, and transmitting the even data and the odd data to a system bus; and a write data control circuit transmitting the internal data strobe signal input from the internal data strobe signal generating circuit to a DDR SDRAM device as a data strobe signal.

### CROSS-REFERENCE TO RELATED APPLICATIONS

This application claims the benefit of Korean Application No. 2003-93226, filed Dec. 18, 2003, in the Korean Intellectual Property Office, the disclosure of which is incorporated herein by reference.

### BACKGROUND OF THE INVENTION

1. Field of the Invention

The present invention relates to a data control circuit for a double data rate (DDR) synchronous dynamic random-access memory (SDRAM) controller. More particularly, the present invention relates to a data control circuit for a DDR SDRAM controller which can stably perform a data reading/writing operation by actively controlling a data strobe signal during a data transmission/reception between a DDR SDRAM and the DDR SDRAM controller.

2. Description of the Related Art

As is well known, in order to increase the data access speed of a DRAM as high as a static random access memory (SRAM) and to obtain a high data bandwidth by a high clock frequency, a synchronous DRAM (SDRAM) has been proposed.

A typical SDRAM is a device that transfers data for one period of a clock in synchronization with a rising edge of the clock, whereas a DDR SDRAM is a device that can transfer data in synchronization with both a rising edge and a falling edge of the clock. Accordingly, the DDR SDRAM can achieve an operating speed at least twice the operating speed of the existing SDRAM without increasing the frequency of the clock.

Since a window of a data signal inputted/outputted to/from the DDR SDRAM is smaller than a window of a data signal inputted/outputted to/from the existing SDRAM, the DDR SDRAM requires a data strobe signal (DQS) for fetching the inputted/outputted data signal. Accordingly, the DDR SDRAM is additionally provided with a separate external pin for inputting the data strobe signal (DQS).

Hereinafter, the basic reading/writing operation of the DDR SDRAM will be explained.

FIGS. 1A-1C are timing diagrams for explaining the basic writing operation of a DDR SDRAM. The writing operation is performed in such a manner that a data strobe signal DQS and data DQ are transmitted from a chip that includes a DDR SDRAM controller to a DDR SDRAM device, and at this time, the data strobe signal DQS should be transmitted in a state that the rising and falling edges of the data strobe signal DQS are aligned into a center part of the data DQ. Accordingly, a write control circuit and a data strobe signal control circuit of the DDR SDRAM controller should generate a signal aligned into the center of the data DQ, and then transmit this signal as the data strobe signal DQS.

FIGS. 2A-2C are timing diagrams for explaining the basic reading operation of the DDR SDRAM. The reading operation is performed in such a manner that the data strobe signal DQS and the data DQ are outputted and transmitted from the DDR SDRAM device to the chip that includes the DDR SDRAM controller, and at this time, the data DQ is transmitted in a state that it is aligned at the rising and falling edges of the data strobe signal DQS.

A data control unit of the DDR SDRAM controller receives the data strobe signal DQS as its clock input of a flip-flop, and captures the data of the DDR SDRAM. In this case, a read data control circuit of the controller should delay the data strobe signal in consideration of a regulation of a setup time and a hold time of the read data. It is most preferable that the time is delayed until the edge of the data strobe signal is aligned into the center of the data in consideration of the regulation of the setup time and the hold time.

According to a conventional method of delaying the data strobe signal, the data strobe signal DQS passes through a buffer having a fixed delay time, or a signal obtained by phase-shifting the system clock is used as the data strobe signal DQS.

In this case, although the delay time between the data DQ and the data strobe signal DQS is kept constant by making the length of wiring between the DDR SDRAM controller and the DDR SDRAM constant, a skew may occur between the data DQ and the data strobe signal DQS due to the characteristics of the wiring and the buffer inside the DDR SDRAM controller.

Accordingly, the flip-flop of the read data control circuit may capture invalid data, thereby causing the whole system not to operate.

Also, when using the buffer having a fixed delay time as in the conventional method, the DDR SDRAM controller cannot actively cope with the change of the operating speed of the DDR SDRAM or the whole system, and thus an addition circuit composed of buffers having diverse delay times to select a proper delay time according to the operating speed is required. However, this complicates the whole system and causes an additional cost.

Also, even if the circuit for selecting the delay time is additionally employed, the phase of the clock may be changed due to environmental factors such as temperature, manufacturing process, and external operation voltage, and this phase change causes the valid data not to be normally captured.

As the DDR SDRAM operates at high speed, the valid data window of the DDR SDRAM becomes narrower, and this exacerbates the problems described above.

### SUMMARY OF THE INVENTION

An aspect of the present invention is to solve the above and/or other problems and disadvantages and to provide at least the advantages described below. Accordingly, an aspect of the present invention is to provide a data control circuit for a double data rate (DDR) synchronous dynamic random-access memory (SDRAM) that secures a stable reading/writing operation of DDR SDRAM data by internally generating and using a data strobe signal located in the center part of valid data.

In order to achieve the above and/or other aspects of the present invention, there is provided a data control circuit for a DDR SDRAM, according to the present invention, which includes an internal data strobe signal generating circuit for generating and outputting an internal data strobe signal DQS_IN a rising edge of which is located in a center part of valid DDR SDRAM data; a read data control circuit for receiving the internal data strobe signal DQS_IN generated from the internal data strobe signal generating circuit as a clock input, dividing captured data into even data and odd data, and transmitting the even data and the odd data to a system bus; and a write data control circuit for transmitting the internal data strobe signal DQS_IN inputted from the internal data strobe signal generating circuit to a DDR SDRAM device as a data strobe signal DQS.

Additional aspects and/or advantages of the invention will be set forth in part in the description which follows and, in part, will be obvious from the description, or may be learned by practice of the invention.

In another aspect of the present invention, the internal data strobe signal generating circuit includes a sampling data generating unit for generating a plurality of sampling data by sampling data at sequential rising edges of a first clock, and generating a plurality of sampling data by sampling data at sequential rising edges of a second clock; a sampling data comparing unit for calculating comparison information of the sampling data based on the sampling data inputted from the sampling data generating unit; a clock shift control signal generating unit for generating a clock shift control signal for compensating phases of the first and second clocks by using the data comparison information inputted from the sampling data comparing unit; a clock phase compensating circuit unit for generating the first and second clocks phase-compensated based on the clock shift control signal and an external reference clock inputted from an external system; and a frequency dividing circuit unit for receiving and dividing a frequency of the second clock by 2, and outputting the internal data strobe signal DQS_IN.

According to an aspect of the present invention, the clock shift control signal includes an up signal, a down signal, and a hold signal.

According to an aspect of the present invention, the up signal is enabled in the case that CpB=1 and CpA=CpC=0, where CpA, CpB and CpC are comparison values outputted from the sampling data comparing unit.

According to an aspect of the present invention, the down signal is enabled in the case that CpA=1 and CpB=CpC=0, where CpA, CpB and CpC are comparison values outputted from the sampling data comparing unit.

According to an aspect of the present invention, the sampling data generating unit includes odd-numbered (2n−1) flip-flop units that receive the first clock as their clock input, and an even-numbered (2n) flip-flop unit that receives the second clock as its clock input.

According to an aspect of the present invention, if n is a natural number, the odd-numbered (2n−1) flip-flop comprises n flip-flops connected in series.

According to an aspect of the present invention, if n is a natural number, the even-numbered (2n) flip-flop unit comprises n flip-flops connected in series.

According to an aspect of the present invention, the sampling data comparing unit receives the plurality of sampling data from the sampling data generating unit, and outputs ‘1’ if values of the plurality of sampling data are identical, while it outputs ‘0’ if the values of the plurality of sampling data are different.

According to an aspect of the present invention, the clock phase compensating circuit unit includes a double-frequency clock generating unit for generating a plurality of clocks twice faster than the inputted external reference clock; a phase inverting unit for inverting a phase of one of the plurality of clocks by 180°, and outputting the first and second clocks having reversed phases to each other; and a clock shifting unit for shifting the first and second clocks to the right for a predetermined distance if the clock shift control signal inputted from the clock shift control signal generating unit is the up signal, and shifting the first and second clocks to the left for a predetermined distance if the inputted clock shift control signal is the down signal.

According to an aspect of the present invention, the clock phase compensating circuit unit includes a duty rate correcting unit for correcting a duty rate of the first and the second clocks to 1:1 if the duty rate of the first and second clocks is not 1:1.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A-1C are timing diagrams for explaining the basic writing operation of a conventional DDR SDRAM;

FIGS. 2A-2C are timing diagrams for explaining the basic reading operation of a conventional DDR SDRAM;

FIG. 3 is a block diagram illustrating the construction of a data control circuit for a DDR SDRAM according to an embodiment of the present invention;

FIG. 4 is a block diagram illustrating the construction of the internal data strobe signal generating circuit of FIG. 3 according to the embodiment of the present invention;

FIG. 5 is a block diagram illustrating the construction of the clock phase compensating circuit unit of FIG. 4;

FIGS. 6A-6F are timing diagrams for explaining a case that an up signal is outputted from the clock shift control signal generating unit;

FIGS. 7A-7F are timing diagrams for explaining a case that a down signal is outputted from the clock shift control signal generating unit; and

FIGS. 8A-8D are timing diagrams for explaining a case in which a hold signal is outputted from the clock shift control signal generating unit.

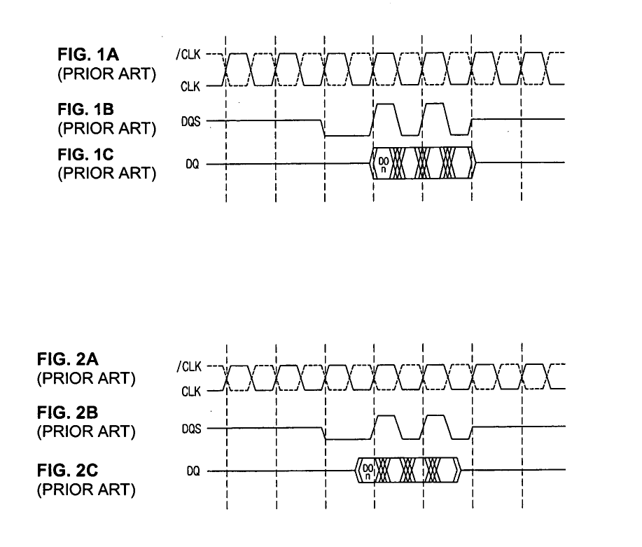

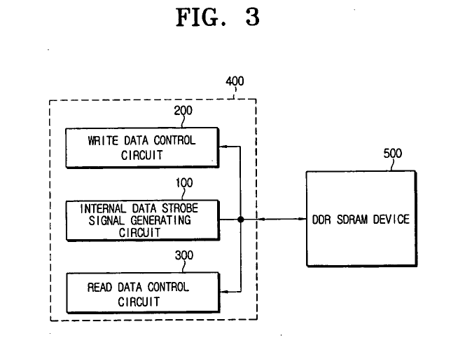

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain embodiments of the present invention by referring to the figures.

FIG. 3 is a block diagram illustrating the construction of a data control circuit for a DDR SDRAM 500 according to an embodiment of the present invention. Referring to FIG. 3, the data control circuit 400 for a DDR SDRAM according to an embodiment of the present invention comprises a write data control circuit 200, a read data control circuit 300, and an internal data strobe signal generating circuit 100.

The internal data strobe signal generating circuit 100 generates and outputs an internal data strobe signal DQS_IN where a rising edge of which is located in a center part of valid data in order to secure a stable reading/writing operation of DDR SDRAM data.

The read data control circuit 300 receives the internal data strobe signal DQS_IN generated from the internal data strobe signal generating circuit 100 as a clock input, divides captured data into even data and odd data, and transmits the even data and the odd data to a system bus (not illustrated).

The write data control circuit 200 transmits the internal data strobe signal DQS_IN input from the internal data strobe signal generating circuit 100 to a DDR SDRAM device 500 as a data strobe signal DQS.

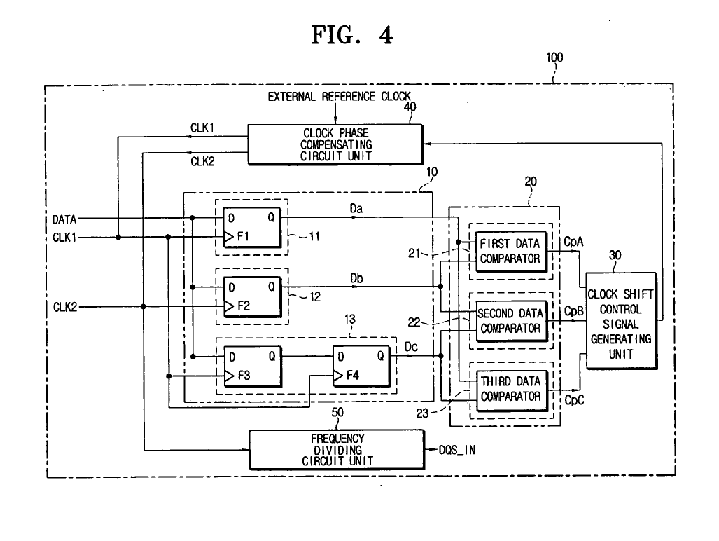

FIG. 4 is a block diagram illustrating the construction of the internal data strobe signal generating circuit of FIG. 3 according to an embodiment of the present invention. Referring to FIG. 4, the internal data strobe signal generating circuit 100 includes a sampling data generating unit 10, a sampling data comparing unit 20, a clock shift control signal generating unit 30, a clock phase compensating circuit unit 40, and a frequency dividing circuit unit 50.

The sampling data generating unit 10 includes a plurality of flip-flops F1 to F4. The sampling data generating unit 10 includes odd-numbered (2n−1) flip-flop units 11 and 13 that receive the first clock CLK1 as their clock input, and an even-numbered (2n) flip-flop unit 12 that receives the second clock CLK2 as its clock input. Each of the odd-numbered (2n−1) flip-flop units 11 and 13 and the even-numbered (2n) flip-flop unit 12 includes n flip-flops connected in series. Here, n is a natural number.

The sampling data generating unit 10 generates and outputs the first sampling data Da obtained by sampling the data at the first rising edge of the first clock CLK1, the second sampling data Db obtained by sampling the data at the first rising edge of the second clock CLK2, and the third sampling data Dc obtained by sampling the data at the second rising edge of the first clock CLK1.

The sampling data comparing unit 20 includes a plurality of data comparators 21 to 23. Three data comparators 21 to 23 compare each of the three sampling data Da to Dc, and output results of the comparisons, respectively, to the clock shift control signal generating unit 30.

The clock shift control signal generating unit 30 generates and outputs a down signal or an up signal in specified cases based on the results of the comparison by the sampling data comparing unit 20, and outputs a hold signal in other cases. The down signal is a signal that decreases the phase of the clock, and the up signal is a signal that increases the phase of the clock. The hold signal is a signal that exerts no effect on the phase change of the clock.

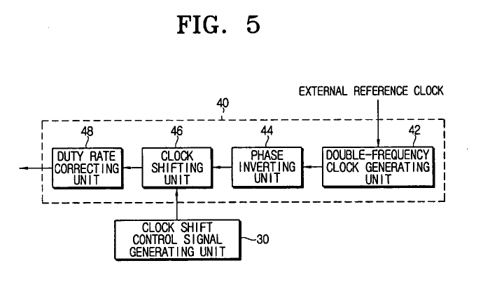

FIG. 5 is a block diagram illustrating the construction of the clock phase compensating circuit unit of FIG. 4. The clock phase compensating circuit 40 includes a double-frequency clock generating unit 42, a phase inverting unit 44, a clock shifting unit 46, and a duty rate correcting unit 48.

The double-frequency clock generating unit 42 generates a plurality of clock signals at least two times faster than the input external reference clock CLK_ref. The reason why the double-frequency clock generating unit generates clocks that are two times faster than the external reference clock is to enable it to perform a sampling.

The phase inverting unit 44 inverts the phase of one of the plurality of clocks from the double frequency clock generating unit 42 by 180°, and outputs the first and second clocks CLK1 and CLK2 having a phase difference of 180° from each other.

The clock shifting unit 46 shifts the first and second clocks CLK1 and CLK2 to the right for a predetermined distance if the input clock shift control signal is the up signal, and shifts the first and second clocks CLK1 and CLK2 to the left for a predetermined distance if the input clock shift control signal is the down signal. If the input clock shift control signal is the hold signal, then there is no phase change between the first clock CLK1 and the second clock CLK2.

The duty rate correcting unit 48 corrects a duty rate of the first and second clocks CLK1 and CLK2 output from the clock shifting unit 46 to 1:1 if the duty rate of the first and second clocks CLK1 and CLK2 is not 1:1. For example, if it is assumed that a high-level section of the second clock CLK2 is L_{H}, and a low-level section is L_{L}, the duty rate correcting unit 48 corrects the duty rate of the first and second clocks CLK1 and CLK2 by making L_{H}:L_{L}=1:1.

In this embodiment, the duty rate correcting unit 48 is implemented in the clock phase compensating circuit unit 40. However, the duty rate correcting unit 48 may also be implemented in the front or in the rear of the frequency dividing circuit unit 50 which will be explained later.

Referring again to FIG. 4, the frequency dividing circuit unit 50 receives the second clock CLK2 output from the clock phase compensating circuit unit 40, and generates the internal data strobe signal DQS_IN by accelerating the frequency of the second clock CLK2 by 1/2 times.

The rising edge of the internal data strobe signal DQS_IN generated from the internal data strobe signal generating circuit 100 is always located in the center part of the valid data, and the internal data strobe signal DQS_IN is input to the read data control circuit 300 and the write data control circuit 200.

The read data control circuit 300 receives the external DDR SDRAM data as a data input of flip-flops (not illustrated) in the read data control circuit 300, and receives the internal data strobe signal DQS_IN generated from the internal data strobe signal generating circuit 100 as a clock input of the flip-flops.

The read data control circuit 300 captures the odd-numbered data at the rising edge of the internal data strobe signal DQS_IN, and captures the even-numbered data at the falling edge of the internal data strobe signal DQS_IN. The captured data are transmitted to the system bus.

The write data control circuit 200 transmits the internal data strobe signal DQS_IN to the DDR SDRAM device 500 along with the write data.

The operation of the data control circuit 400 for a DDR SDRAM controller as constructed above according to an embodiment of the present invention will be explained in detail with reference to FIG. 4.

The first flip-flop F1 of the first odd-numbered flip-flop unit 11 in the sampling data generating unit 10 receives the data DQ as its input and the first clock CLK1 as its clock input, and generates the first sampling data Da by sampling the data DQ at the rising edge of the first clock CLK1.

The second flip-flop F2 of the even-numbered flip-flop unit 12 receives the second clock CLK2 as its clock input, and generates the second sampling data Db by sampling the data DQ at the rising edge of the second clock CLK2.

The third flip-flop F3 of the second odd-numbered third flip-flop unit 13 receives the first clock CLK1 as its clock input, and generates and outputs the first sampling data Da by sampling the data at the next rising edge of the first clock CLK1. The fourth flip-flop F4 receives the first sampling data Da from the third flip-flop F3 as its input and the first clock CLK1 as its clock input, and generates and outputs the third sampling data Dc.

The three sampling data Da, Db and Dc output from the sampling data generating unit 10 are input to the sampling data comparing unit 20.

The sampling data comparing unit 20 includes data comparators in the same number as the sampling data. For example, in FIG. 4 the sampling data comparing unit 20 includes the first data comparator 21, the second data comparator 22, and the third data comparator 23 to compare the three sampling data Da, Db and Dc, respectively.

The first data comparator 21 receives Da and Db, and outputs ‘CpA=1’ if Da=Db, and outputs ‘CpA=0’ if Da≠Db.

The second data comparator 22 receives Db and Dc, and outputs ‘CpB=1’ if Db=Dc, and outputs ‘CpB=0’ if Db≠Dc.

The third data comparator 23 receives Dc and Da, and outputs ‘CpC=1’ if Dc=Da, and outputs ‘CpC=0’ if Dc≠Da.

The comparison values CpA, CpB and CpC output from the sampling data comparing unit 20 are input to the clock shift control signal generating unit 30. The clock shift control signal generating unit 30 generates and outputs a specified shift signal by using the comparison values CpA, CpB and CpC. It is preferable, but not required, that the clock shift control signal generating unit 30 is implemented by a general logic circuit. The shift signal includes the up signal, the down signal and the hold signal. The up signal is a signal that increases the phase of the clock, the down signal is a signal that decreases the phase of the clock, and the hold signal is a signal that exerts no effect on the phase of the clock.

The down signal is enabled if CpA=1 and CpB=CpC=0, that is, if Da=Db and Da (or Db)≠Dc. The up signal is enabled if CpB=1 and CpA=CpC=0, that is, if Db=Dc and Db (or Dc)≠Da. Otherwise, the up signal and the down signal are disabled, and the hold signal is output. The hold signal does not change the phase of the clock.

The generation of the clock shift signals based on the results of data comparison is represented by the following truth table.

TABLE 1

| CpA | CpB | CpC | Down | Up |
|---|---|---|---|---|
| 0 | 0 | 0 | 0 | 0 |
| 0 | 0 | 1 | 0 | 0 |
| 0 | 1 | 0 | 0 | 1 |
| 0 | 1 | 1 | 0 | 0 |
| 1 | 0 | 0 | 1 | 0 |
| 1 | 0 | 1 | 0 | 0 |
| 1 | 1 | 0 | 0 | 0 |
| 1 | 1 | 1 | 0 | 0 |

In Table 1, if the down signal is ‘1’, the down signal is generated and output, and if the up signal is ‘1’, the up signal is generated and output. In other cases, the hold signal is output.

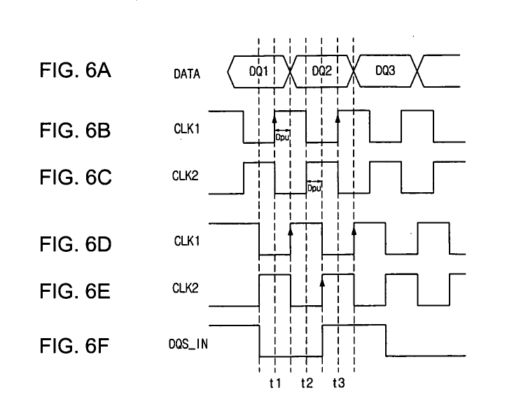

FIGS. 6A-6F are timing diagrams for explaining a case that the up signal is output from the clock shift control signal generating unit 30. As shown in FIGS. 6B and 6C, the first sampling data Da sampled at the rising edge t1 of the first clock CLK1 has a value of DQ1, and the second sampling data Db sampled at the rising edge t2 of the second clock CLK2 and the third sampling data Dc sampled at the next rising edge t3 of the first clock CLK1 have a value of DQ2.

In essence, since Da≠Db=Dc, which means that CpB=1 and CpA=CpC=0, the up signal is output as shown in Table 1.

The output up signal is input to the clock shifting unit 46 of the clock phase compensating circuit unit 40. Referring to FIGS. 6D and 6E, the clock shifting unit 46 recognizes the input up signal, and locates the rising edge of the second clock CLK2 in the center part of the data DQ2 by shifting the first clock CLK1 and the second clock CLK2 to the right for a predetermined distance Dpu.

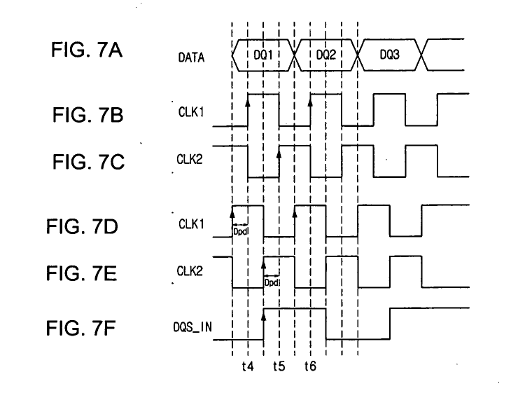

FIGS. 7A-7F are timing diagrams for explaining a case that the down signal is output form the clock shift control signal generating unit 30.

As shown in FIGS. 7B and 7C, the first sampling data Da sampled at the rising edge t4 of the first clock CLK1 and the second sampling data Db sampled at the rising edge t5 of the second clock CLK2 have the same value of DQ1, and the third sampling data Dc sampled at the next rising edge t6 of the first clock CLK1 has a value of DQ2.

In essence, since Da=Db≠Dc, which means that CpA=1 and CpC=CpB=0, the down signal is output as shown in Table 1.

In the same manner as described above, the output down signal is inputted to the clock shifting unit 46 of the clock phase compensating circuit unit 40. Referring to FIGS. 7D and 7E, the clock shifting unit 46 recognizes the input down signal, and locates the rising edge of the second clock CLK2 in the center part of the data DQ1 by shifting the first clock CLK1 and the second clock CLK2 to the left for a predetermined distance Dpd.

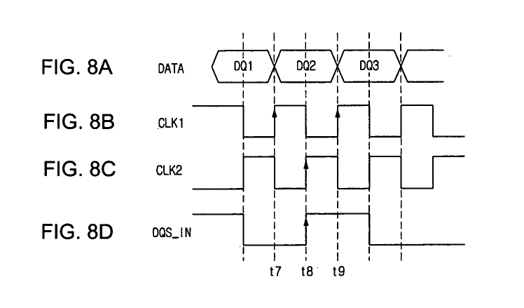

FIGS. 8A-8D are timing diagrams for explaining a case that the hold signal is output from the clock shift control signal generating unit.

As shown in FIGS. 8B and 8C, the first sampling data Da sampled at the rising edge t7 of the first clock CLK1, the second sampling data Db sampled at the rising edge t8 of the second clock CLK2, and the third sampling data Dc sampled at the next rising edge t9 of the first clock CLK1 have the same value of DQ2. Accordingly, CpA=CpB=CpC=1, and therefore, the up signal and the down signal are disabled as shown in Table 1. In this case, the hold signal is output, and therefore, the phases of the first and second clocks CLK1 and CLK2 are not changed.

The clock shift control signal generated through the above-described process is input to the clock shifting unit 46 of the clock phase compensating circuit unit 40.

Referring again to FIG. 5, the double-frequency clock generating unit 42 in the clock phase compensating circuit unit 40 receives the external reference clock from the external system (not shown) such as a personal computer, and generates a plurality of clocks two times faster than the external reference clock.

The plurality of clocks output from the double-frequency clock generating unit 42 is input to the phase inverting unit 44. The phase inverting unit 44 receives any one of the plurality of clocks, and outputs a plurality of first and second clocks CLK1 and CLK2 by inverting the phase of at least one of the received clocks by 180°. In an embodiment of the present invention, the phase inverting unit 44 inverts the second clock CLK2 among the plurality of clocks by 180°.

The first and second clocks CLK1 and CLK2 output from the phase inverting unit 44 are input to the clock shifting unit 46. The clock shifting unit 46 receives the clock shift control signal from the clock shift control signal generating unit 30, and changes the phases of the first and second clocks CLK1 and CLK2 according to the clock shift control signal. At this time, the input clock shift control signal includes the up signal, the down signal, and the hold signal. Since the phase shift of the first and second clocks CLK1 and CLK2 is performed in the same manner as described above, the detailed explanation thereof will be omitted.

The first and second clocks CLK1 and CLK2 output from the clock shifting unit 44 are input to the duty rate correcting unit 48. The duty rate correcting unit 48 corrects the duty rate of the first and second clocks CLK1 and CLK2 output from the clock shifting unit 46 to 1:1 if the duty rate of the first and second clocks CLK1 and CLK2 is not 1:1. If it is assumed that a high-level section of the second clock CLK2 is L_{H}, and a low-level section is L_{L}, the duty rate correcting unit 48 corrects the duty rate of the first and second clocks CLK1 and CLK2 to satisfy L_{H}:L_{L}=1:1.

The duty rate correcting unit 48 shown in FIG. 5 is implemented in the clock phase compensating circuit unit 40. However, the duty rate correcting unit 48 may be implemented in the front or in the rear of the frequency dividing circuit unit 50 which will be explained later.

The first and second clocks CLK1 and CLK2 output from the clock phase compensating circuit unit 40 through the above-described process are fed back as the clock inputs of the flip-flops F1 to F4 of the sampling data generating unit 10. The first clock CLK1 is fed back as the clock input of the odd-numbered flip-flops, and the second clock CLK2 is fed back as the clock input of the even-numbered flip-flop. In FIG. 4, the first clock CLK1 is fed back as the clock inputs of the first flip-flop F1 and the third flip-flop F3, and the second clock CLK2 is fed back as the clock input of the second flip-flop F2.

The second clock CLK2 is input to the frequency dividing circuit unit 50, and is simultaneously being fed back as the clock input of the even-numbered flip-flop. The frequency dividing circuit unit 50 receives the second clock CLK2 output from the clock phase compensating circuit unit 40, and generates the internal data strobe signal DQS_IN by accelerating the frequency of the second clock CLK2 by 1/2 times.

Referring to FIG. 6F, FIG. 7F, and FIG. 8D, by locating the rising edge of the internal data strobe signal DQS_IN generated through the above-described process in the center part of the valid data, the reading/writing operation of the DDR SDRAM data can be stabilized.

The internal data strobe signal DQS_IN generated from the internal data strobe signal generating circuit 100 is input to the read data control circuit 300 and the write data control circuit 200.

As described above, the data control circuit for a DDR SDRAM according to an embodiment of the present invention can generate an internal data strobe signal actively controllable irrespective of the operating speed of the DDR SDRAM, the operating speed of the whole system, the valid data window, and the skew between the data strobe signal and the data signal, and thus can secure a stable reading/writing operation of the DDR SDRAM data.

Although a few embodiments of the present invention have been shown and described, it would be appreciated by those skilled in the art that changes may be made in this embodiment without departing from the principles and spirit of the invention, the scope of which is defined in the claims and their equivalents.

1. A data control circuit for a double data rate (DDR) synchronous dynamic random-access memory (SDRAM), comprising:
an internal data strobe signal generating circuit generating and outputting an internal data strobe signal, a rising edge of which is located in a center part of valid DDR SDRAM data;
a read data control circuit receiving the internal data strobe signal generated from the internal data strobe signal generating circuit as a clock input, dividing captured data into even data and odd data, and transmitting the even data and the odd data to a system bus; and
a write data control circuit transmitting the internal data strobe signal input from the internal data strobe signal generating circuit to the DDR SDRAM memory as a data strobe signal.

2. The data control circuit as claimed in claim 1, wherein the internal data strobe signal generating circuit comprises:
a sampling data generating unit generating and outputting a plurality of sampling data by sampling the data at sequential rising edges of a first clock, and by sampling the data at sequential rising edges of a second clock;
a sampling data comparing unit calculating comparison information of the sampling data input from the sampling data generating unit;
a clock shift control signal generating unit generating and outputting a clock shift control signal compensating phases of the first and second clocks by using the comparison information input from the sampling data comparing unit;
a clock phase compensating circuit unit phase compensating the first and second clocks based on the clock shift control signal and an external reference clock and a frequency dividing circuit unit receiving and dividing a frequency of the second clock by 2, and outputting the internal data strobe signal.

3. The data control circuit as claimed in claim 2, wherein the sampling data generating unit comprises odd-numbered (2n−1) flip-flop units that receive the first clock as an odd-numbered flip flop clock input, and an even-numbered (2n) flip-flop unit that receives the second clock as an even-numbered flip flop clock input.

4. The data control circuit as claimed in claim 3, wherein if n is a natural number, the odd-numbered (2n−1) flip-flop units comprise n flip-flops connected in series.

5. The data control circuit as claimed in claim 3, wherein if n is a natural number, the even-numbered (2n) flip-flop unit comprises n flip-flops connected in series.

6. The data control circuit as claimed in claim 2, wherein the sampling data comparing unit receives the plurality of sampling data from the sampling data generating unit, and outputs ‘1’ if values of the plurality of sampling data are identical, while the sampling data comparing unit outputs ‘0’ if the values of the plurality of sampling data are different.

7. The data control circuit as claimed in claim 2, wherein the clock shift control signal includes an up signal, a down signal, and a hold signal.

8. The data control circuit as claimed in claim 7, wherein the up signal when CpB=1 and CpA=CpC=0;
wherein CpA, CpB and CpC are comparison values output from the sampling data comparing unit.

9. The data control circuit as claimed in claim 7, wherein the down signal is enabled when CpA=1 and CpB=CpC=0;
wherein CpA, CpB and CpC are comparison values output from the sampling data comparing unit.

10. The data control circuit as claimed in claim 7, wherein the hold signal is generated and output when the up signal and the down signal are disabled.

11. The data control circuit as claimed in claim 7, wherein the clock phase compensating circuit unit comprises:
a double-frequency clock generating unit generating the first and second clocks at a frequency which is at least double the frequency the input external reference clock;
a phase inverting unit inverting a phase of one of the first and second clocks by 180°, and outputting the first and second clocks having inversed phases with respect to each other; and
a clock shifting unit for shifting the first and second clocks to the right for a predetermined distance if the clock shift control signal input from the clock shift control signal generating unit is the up signal, and shifting the first and second clocks to the left for a predetermined distance if the input clock shift control signal is the down signal.

12. The data control circuit as claimed in claim 11, wherein the clock phase compensating circuit unit further comprises a duty rate correcting unit correcting a duty rate of the first and the second clocks to 1:1 if the duty rate of the first and second clocks is not 1:1.

13. A double data rate synchronous dynamic random access memory (DDR SDRAM) device, comprising:
a DDR SDRAM memory storing data; and
a DDR SDRAM memory control circuit comprising:
an internal data strobe signal generating circuit which receives the data and an external clock and generates an internal data strobe signal having a rising edge located in a middle portion of the data and is responsive to first and second clock signals generated based on the external clock,
a read data control circuit which parses the data into even data and odd data based on the internal data strobe signal, and
a write data control circuit which generates a data strobe signal, according to the internal data strobe signal, which controls the transfer of the data with the DDR SDRAM memory.

14. The device of claim 13, wherein the read data control circuit parses the odd data responsive to the rising edge of the internal data strobe signal.

15. The device of claim 13, wherein the read data control circuit parses the even data responsive to the falling edge of the internal data strobe signal.

16. The device of claim 13, wherein the internal data strobe signal generating circuit comprises:
a sampling data generating unit which samples the data at sequential rising edges of the first clock, and at sequential rising edges of the second clock signal;
a sampling data comparing unit which compares the sampled data from the sampling data generating unit and outputs comparison results;
a clock shift control signal generating unit which generates a clock shift control signal based on the comparison results from the sampling data comparing unit;
a clock phase compensating circuit which adjusts a phase of at least one of the first and second clock signals according to the clock shift control signal; and
a frequency dividing circuit which receives adjusts the frequency of the second clock signal to result in the internal data strobe signal.

17. The device of claim 16, wherein the sampling data generating unit comprises:
first and third flip flops which receive the data responsive to the first clock signal;
a second flip flop which receives the data responsive to the second clock signal; and
a fourth flip flop which receives data output from the third flip flop, and the fourth flip flop is responsive to the first clock signal.

18. The device of claim 16, wherein the clock shift control signal comprises one of an up clock shift control signal increasing the phase of one of the first and second clock signals, a down clock shift control signal decreasing the phase of one of the first and second clock signals, and a hold clock shift control signal maintaining the phase of the first and second clock signals based on the comparison results.

19. The device of claim 18, wherein the clock phase compensating circuit adjusts one of the first and second clock signals such that a phase of the adjusted clock signal lags a phase of the other clock signal.

20. The device of claim 19, wherein the second clock lags the first clock by 180 degrees.

21. The device of claim 16, wherein the frequency dividing circuit increases the frequency of the second clock signal.

22. The device of claim 16, wherein the frequency dividing circuit divides the frequency of the second clock signal by 2.

23. A method of controlling data transfer with a double data rate synchronous dynamic random access memory (DDR SDRAM), comprising:
generating an internal data strobe signal having a rising edge in the center of the data;
parsing the data according to the internal data strobe signal;
generating a data strobe signal according to the internal data strobe signal; and
controlling the data transfer with the DDR SDRAM according to the data strobe signal.

24. The method of claim 23, controlling the internal data strobe signal irrespective of a skew between the data strobe signal and the data.

25. A method of controlling data transfer with a double data rate synchronous dynamic random access memory (DDR SDRAM), comprising:
generating an internal data strobe signal in a center of the data, the internal data strobe signal actively controllable irrespective of an operating speed of the DDR SDRAM;
parsing the data according to the internal data strobe signal;
generating a data strobe signal according to the internal data strobe signal; and
controlling the data transfer with the DDR SDRAM according to the data strobe signal.

26. The method of claim 25, further comprising:
controlling the internal data strobe signal independently of a speed of a computer system comprising the DDR SDRAM.
